(19) United States
(12) Patent Application Publication
(10) Pub. No.: US 2003/0042860 A1
(43) Pub. Date: Mar. 6, 2003

(54) System and method of controlling airflow in an air delivery system

(76) Inventor: Louis E. Sulfstede, Irving, TX (US)

Correspondence Address: Michael L. Diaz, Michael L. Diaz, P.C., Suite 200, 555 Republic Drive, Plano, TX, 75074, US

(21) Appl. No.: 10/234,264

(22) Filed: Sep. 4, 2002

Related U.S. Application Data
(60) Provisional application No. 60/317,323, filed on Sep. 5, 2001.

(51) Int. Cl. H02P 7/00

(52) U.S. Cl. 318/432

(57) ABSTRACT

A system and method of controlling airflow within an air delivery system. The method begins by identifying and measuring a particular air conditioning system's blower characteristics. A mathematical relationship for finding a particular CFM based on torque and speed is developed utilizing several discrete airflows within regions or bins within a designated range. The mathematical model is employed by a controller of the air conditioning system for controlling CFM. Additionally, the method may optionally change from an airflow control mode to a blower speed or torque control mode when restrictions are placed upon the air conditioning system.

### RELATED APPLICATIONS

This utility application claims the priority date of Provisional Patent Application Serial No. 60/317,323 filed Sep. 5, 2001 and is hereby incorporated by reference.

### BACKGROUND OF THE INVENTION

1. Technical Field of the Invention

This invention relates to the control of delivered air in air delivery systems and, more particularly, to a system and method of controlling airflow by a discrete bin airflow mathematical model in an air delivery system.

2. Description of Related Art

There have been many systems implemented to optimize airflow within an air conditioning system. Typically, the air conditioning system includes a device to condition the temperature of the air, with the delivery rate of the conditioned air regulated by a motor driving a blower. Many factors affect the amount of air and the rate of air delivery (often measured as CFM-cubic feet per minute). Such factors include the blower wheel design and type, the motor's speed and torque, restrictions associated with the blower, and the temperature and density of the air.

In most situations, it is highly desirable to provide a controlled airflow to the air space. Controllers located within existing air conditioning systems are used to control the speed or torque of the motor driving the blower or adjust dampers to provide the desired airflow. Those controllers that adjust the motor's performance set the desired airflow based upon an airflow performance mathematical model. As an example, in order to develop a constant airflow performance model, the relevant factors influencing the CFM include the motor's speed and torque, the blower's airflow, and static pressure of the environment are modeled. Since the torque and speed of the motor are related to the restriction on the blower at a given airflow, the model of this airflow may relate air mass or volume (if density is known) per unit time to torque and speed of the motor. Therefore, at a specified torque and speed of a motor, the air delivered into a restriction can be approximated.

In order to determine a mathematical model of constant airflow for all types of fans, complicated formulas must be utilized employing factors dependent upon the characteristics and performance of the specific type of blower of each air conditioning system. However, the derived mathematical model for one blower or fan cannot produce controlled CFM representations for all blower geometries, sizes, or air conditioning systems. Using such a generalized mathematical model, requires complex computations and significant processing resources. Thus, to facilitate the preferred airflow process control within air conditioning systems, costly resources must be used.

Although there are no known prior art teachings of a solution to the aforementioned deficiency and shortcoming such as that disclosed herein, a prior art reference that discuss subject matter that bears some relation to matters discussed herein is U.S. Pat. No. 4,806,833 to Young (Young). Young discloses a method of operating an air conditioning system. The system includes a variable speed blower for flowing the conditioned air through a contained space having a static pressure. The speed of the blower is set to affect a preselected flow rate at an existing static pressure in the contained space. The speed of the blower is altered only in response to a variation in the static pressure and only in relation with the static pressure variation. The speed alteration of the blower sensed and the speed of the blower is adjusted in relation with the sensed speed alteration to establish the preselected flow rate through the contained space at the varied static pressure acting on the blower. However, Young does not teach or suggest a system or method of determining and implementing a particular CFM based on torque and speed by utilizing mathematical computations developed utilizing several discrete airflows within regions or bins within a designated range. Young suffers from the disadvantage of requiring an air conditioning controller to utilizing complex mathematical computations to select the desired CFM based on static pressure across the entire operation region.

A system and method is needed which does not require complex computations or processing resources to predict CFM performance. The present invention provides such a system and method.

### SUMMARY OF THE INVENTION

In one aspect, the present invention is an air delivery system. The air delivery system includes a blower for delivering an air flow to a specified area and a motor for driving the blower. The air delivery system also includes a controller for controlling air delivery to the specified area. The controller determines a torque and revolutions per minute (RPM) of the motor to produce a desired cubic feet per minute (CFM) air flow from a plurality of discrete airflows within bins. The controller commands the motor to the determined torque and RPM. The motor drives the blower to deliver the air flow at the desired CFM air flow.

In another aspect, the present invention is a method of controlling an air delivery system. The method begins by determining a total fan performance of a blower over an operational range of the air delivery system. Next, a unique mathematical relationship based on torque and speed of a motor driving the blower to create a plurality of discrete airflows is developed. Each discrete airflow provides a specific CFM air flow. A controller of the air delivery system utilizes the unique mathematical relation to control the RPM and torque of the motor to deliver a desired CFM airflow.

In still another aspect, the present invention is a method of controlling an air delivery system utilizing a variable limit. The method begins by determining a total fan performance of a blower over an operational range of the air delivery system. Next, a unique mathematical relationship of CFM airflow related to torque and RPM of a motor driving the blower to create a plurality of discrete airflows within the operational range of the air delivery system is calculated. It is then determined if a controlled airflow mode or a constant torque mode is desired for the air delivery system. If a controlled airflow mode is determined, a controller of the air delivery system utilizes the unique mathematical relationship for a specific discrete airflow to control the RPM and torque of the motor to deliver a desired CFM airflow. However, if it is determined that a constant torque mode is desired for the air delivery system, the controller commands a constant torque to the motor to permit the blower to respond to normal fan curve performance models.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 (Prior Art) is a graphical representation of a plurality of rates of air flow (CFM-cubic feet per minute) based upon speed and horsepower of a motor within an existing air conditioning system;

FIG. 2 is a graphical representation of CFM curves utilizing discrete airflow regions according to the teachings of the present invention;

FIG. 3 is a simplified block diagram illustrating the components of an air conditioning system in the preferred embodiment of the present invention;

FIG. 4 is a flow chart outlining the steps of calculating and implementing a discrete bin control model within the air conditioning system according to the teachings of the present invention;

FIG. 5 is a flow chart outlining the steps of implementing airflow control in the air conditioning system utilizing a variable limit according to the teachings of the present invention;

FIG. 6 illustrated a top view of an existing forward curved blower;

FIG. 7 illustrates the blower characteristics of the exemplary forward curved blower of FIG. 6;

FIG. 8 illustrates a top view of an existing backward-inclined blower; and

FIG. 9 illustrates the blower characteristics of the backward inclined blower of FIG. 8.

### DETAILED DESCRIPTION OF EMBODIMENTS

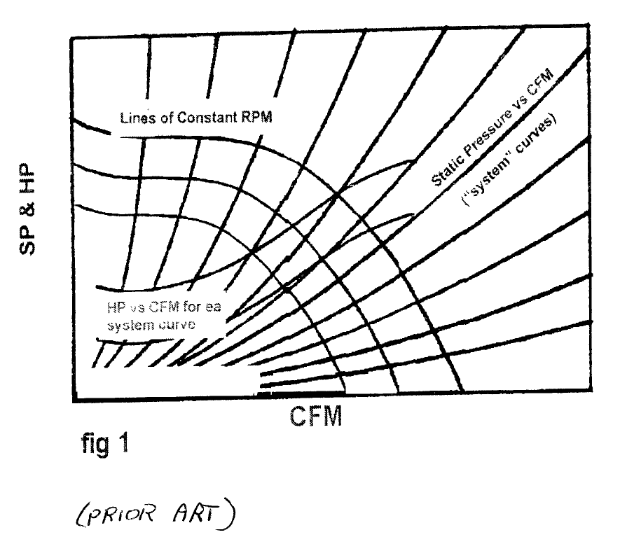

FIG. 1 is a graphical representation of a plurality of rates of air flow (CFMs-cubic feet per minute) based upon speed and horsepower of a motor within an existing air conditioning system. To produce a specific airflow performance from a mathematical model, a blower's specified performance data or an air conditioning system and its motor characteristics are measured and quantified. Specifically, the blower's airflow, and the motor's speed and torque are shown in FIG. 1. The torque and speed of the blower are related to the restriction on the blower at a given airflow. From this specific torque and speed of the motor, an air flow rate is derived. In order to find the specific characteristics of each individual and unique blower system, airflow is measured in a laboratory across the full range of external restrictions. The measured data is used to create a mathematical formula of the form CFM=f(T,S) that serves as a model to describe the physics of the process. There are various models which can be used to describe the measured data of the blower. However, any specific formula is dependent upon the characteristics and performance of the blower utilized in the air conditioning system.

The mathematical model so derived is defined over more than two dimensions and typically involves finding torque-speed solutions using exponential or logarithmic equations for any specified CFM at any blower system restriction. For example, formulas such as the following can be used:

CFM=Ko*logRPM+K1*logT+K2 or

CFM+Ko*RPMˆ K1+K2*Tˆ K3+K4.

Where: T=Torque, RPM=blower speed, and Kx are constants. Such mathematic models approximate the system fan laws and power curves. FIG. 1 is an example of such a graphical representation describing airflow in terms of the torque and speed of the motor needed to hold airflow delivered by a particular blower configuration constant through a range of external restrictions over a range of commanded air flows. Performance data of fans and blowers is published by the fan manufacturer as part of the blower specification. FIG. 1 is an exemplified representation of such published data.

Referring to FIG. 1, the Y axis measures the speed/horsepower of the motor, while the X axis illustrates specific CFMs. Lines of constant RPM and static pressure vs. CFM curves are also illustrated. Because of the shape variations among blowers of different types, it should be noted that one particular mathematical model will not be capable of producing airflow control in all blower geometries, sizes or systems.

Some existing air conditioning systems use the mathematical model similar to the example shown in FIG. 1 to monitor speed and adjust motor current to maintain CFM as commanded. By using complex mathematical computations, significant processing resources must be employed within the motor control system to compute and control the desired CFM.

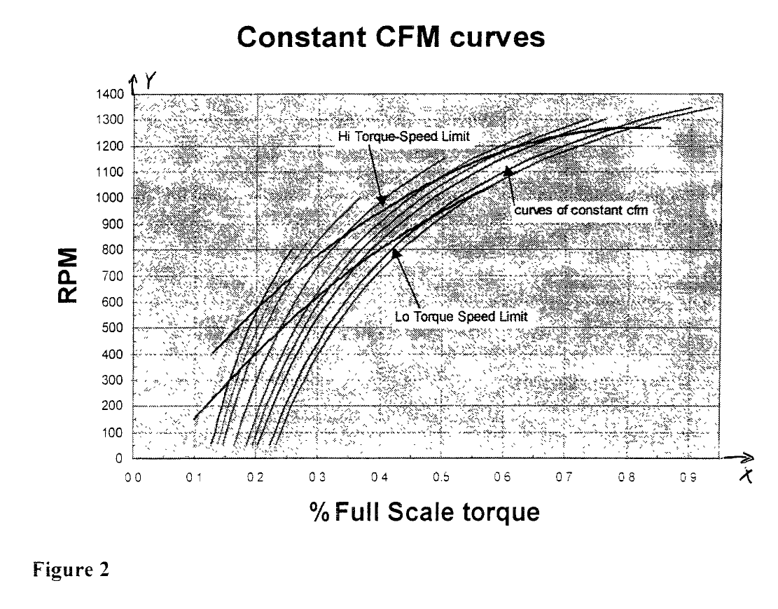

FIG. 2 is a graphical representation of CFM airflow curves utilizing discrete airflow regions according to the teachings of the present invention. Rather than applying complex computations as shown in FIG. 1, a model may be calculated to cover a range of blower characteristics. Once total fan performance is modeled over the operational range utilizing the mathematical relationship of: CFM=f(Torque, RPM) specific to the blower configuration, several discrete airflows within that range can be defined by a unique equation that relates speed and torque of a specified narrow range of restrictions relevant to that discrete airflow. With the speed of the blower motor known, torque can be computed from the calculated equation and used to control CFM to the desired value required by the air conditioning system. Thus, discrete regions or bins are established through the range of the blower's performance. For example, for a particular blower configuration, each discrete step equation could be of the form:

T=K*RPMˆ 2+K1*RPM+K2 for the discrete airflow, known as CFMi. For other blower wheels or blower configurations, the discrete equations may be third order in form, but would relate only speed to torque, not CFM to speed and torque.

An example for controlling airflow to a series of constant values is shown in FIG. 2. A family of constant CFM curves for a mathematical model derived from data taken for a particular blower is illustrated. Each curve has a representative second order equation that relates torque to speed for each CFM curve over a narrower range of relevant external static pressure regions. The Y axis represents RPM of the blower, while the X axis represents percentage of full scale motor torque. In addition, a low torque and high torque limit may be represented at points on the curves.

By utilizing a process in which airflow control is accomplished in bins or regions through the range of the blower's performance using local equations to describe the blower torque and speed, the implementation of the airflow control is considerably simpler and has much broader application than by utilizing a single generalized mathematical model. In addition, since a complex multidimensional mathematical model does not need to be stored in the control system, processing resources and associated complexities inherent in complex computing are significantly reduced. Also, the mathematical solutions for torque and speed are much easier to compute from the discrete regional relations as compared to finding solutions to the overall multidimensional mathematical model, especially when transcendental mathematical terms are used. This can result in reduced implementation cost.

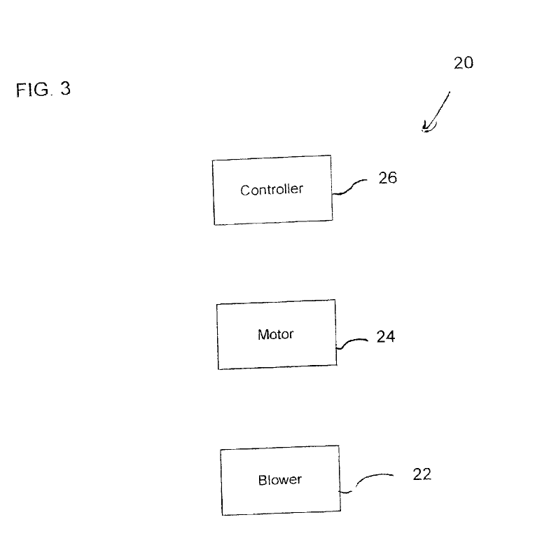

To implement this simpler process, merely the coefficients of the localized equations need be stored. Each set is called up for computation only when commanded at a particular blower airflow in the specified bin. FIG. 3 is a simplified block diagram illustrating the components of an air conditioning system 20 in the preferred embodiment of the present invention. The air conditioning system may be any heating, ventilation, air conditioning (HVAC) or air delivery system employing the controller 26. System 20 includes a blower 22 driven by a motor 24 and controlled by a controller 26. The blower delivers airflow over a particular region. The controller commands the airflow from the motor so that it calculates and adjusts torque and RPM to produce the desired CFM. The controller may include a computing system to calculate and receive mathematically relationships or programs. The controller is normally located external of the motor's internal controls. For simplification, not all components are illustrated within the air conditioning system 20.

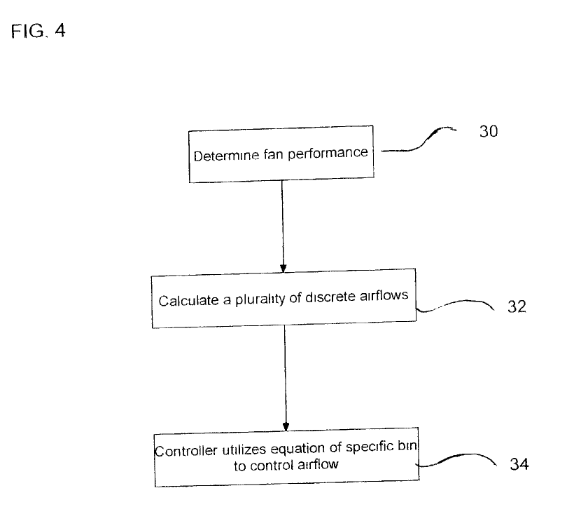

FIG. 4 is a flow chart outlining the steps for calculating and implementing a discrete bin control model within the air conditioning system 20 according to the teachings of the present invention. With reference to FIGS. 2-4, the steps of the method will now be explained. The method begins in step 30, where the total fan performance over an operational range of air conditioning system 20 is determined. Next, in step 32, the mathematical relationship of CFM=f(Torque, Speed) for the specified configuration of the air conditioning system 20 is used to calculate a plurality of discrete airflows within the range. The discrete airflows within the specified range are defined by a unique equation describing a “bin” that relates the speed and torque of the motor 24 over the narrow range of restrictions relevant to that discrete airflow. Next, in step 34, the controller 26 utilizes the unique equation of the specified bin to control the RPM and torque of the motor to deliver the desired CFM.

In addition to the disadvantages discussed above for a general mathematical model to determine CFM described in FIG. 1, another disadvantage of the generalized mathematical model of FIG. 1 is that consideration is not given to any speed and torque restrictions (except for a maximum torque when any airflow in the range of permissible air flows is commanded). Because it has no knowledge of these considerations, the blower may operate at inappropriately high or low RPM under high or low external restrictions.

For example, in an existing system utilizing a general mathematical model of FIG. 1, when a high airflow is commanded (e.g., 1200 cubic feet per minute), the total restriction at the inlet and outlet of the blower might cause the system and motor controller to compute and command a high torque, which may be near the maximum output of the motor. This command in high torque results in the blower running at a very high RPM and high power consumption because such RPM would be needed for the blower to deliver the commanded airflow into such a high restriction. Alternatively, at a much lower commanded airflow (e.g., 600 CFM), the same restriction on the blower does not require the blower to operate at 1300 RPM to deliver 600 CFM. Thus, there is no reason to permit such high speed operation of the motor at the lower commanded airflow. In addition, if restriction of the system is increased so high as to require full blower speed at the lower commanded airflow, such an operation would create an unacceptably high blower noise and high power consumption.

In the preferred embodiment of the present invention, a variable limit across the full airflow range may be implemented to control and limit torque and speed within the air conditioning system 20. When the blower is requested to deliver less than the system's maximum airflow, the permissible torque limit may be reduced to a value appropriate to the blower's performance curves. Thus, the blower would automatically transition from an airflow control mode to a constant torque or constant speed mode in the presence of restrictions beyond what is reasonable for the airflow commanded. The effect of this transition would be that the blower stops accelerating to an excessive speed and permits the air volume to drop under the abnormally restricted condition.

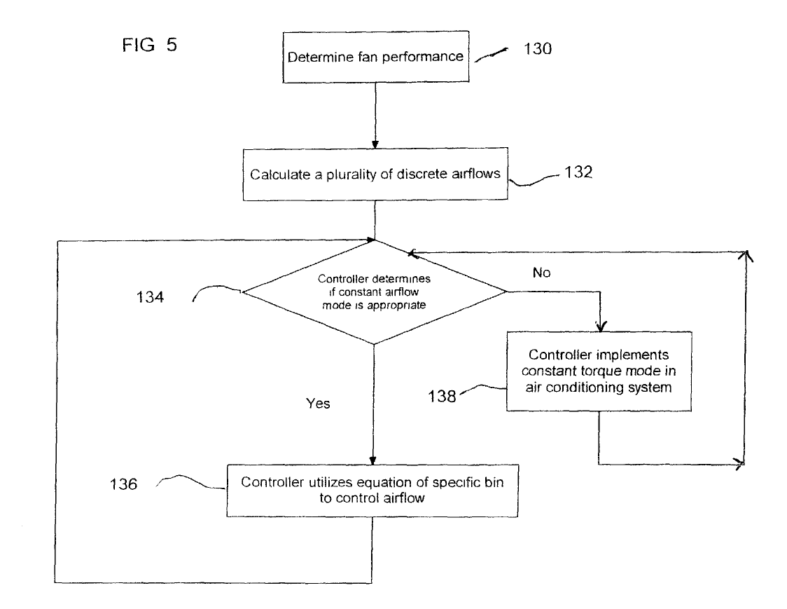

FIG. 5 is a flow chart outlining the steps of implementing airflow control in the air conditioning system 20 utilizing a variable limit according to the teachings of the present invention. With reference to FIGS. 3 and 5, the steps of the method will now be explained. The method begins in step 130, where the total fan performance over an operational range of the air conditioning system 20 is determined. Next, in step 132, the mathematical relationship of CFM=f(Torque, RPM) for the specified configuration of the air conditioning system 20 is used to calculate a plurality of discrete airflows within the range. The discrete airflows within the specified range are defined by a unique equation relating the speed and torque of the motor over the narrow range of restrictions relevant to that discrete airflow. Next, in step 134, it is determined by the controller 26 if a constant airflow mode or constant torque mode is desired in the air conditioning system 20. The controller determines the appropriate mode based on what is programmed within the controller as feasible for the airflow to prevent acceleration to an excessive speed and whereby air volume drop is appropriate. If it is determined that the CFM is appropriate, the method moves from step 134 to step 136 where the controller 26 utilizes the unique equation of the specified bin to control the RPM and torque of the motor to deliver the desired CFM. The method then moves back to step 134 to continue determining which mode is the most appropriate.

However, if it is determined that the constant torque mode is appropriate, the method moves from step 134 to step 138 where the control commands constant torque, stops the blower from accelerating to an excessive speed, permits the blower to respond to normal fan curve performance models and permits the air volume to drop under the abnormally restricted condition. The method then moves from step 138 back to 134 where the controller continues to determine the appropriate mode of operation (for example, constant CFM vs. constant torque).

An example where such a variable limit methodology is particularly advantageous can be seen in a non-ducted, free discharge blower whose discharge vents are accessible in the conditioned space. In such systems, restrictions can easily be inadvertently created on the system. For example, a small fan coil or air conditioning blower in a school classroom may have papers or books placed on its discharge registers. With a constant CFM-controlled blower, the blower changes speed dramatically to maintain the same airflow that was present before the addition of the outlet restrictions. In the situation where airflow was already at a high level of delivery, the blower may be operating at some maximum limit. Therefore, in such a situation, high airflow would be acceptable. However, if the blower was operating at a low airflow, placing paper or books on the discharge registers might add enough restriction to the system to drive the blower to a maximum RPM. By utilizing the variable limit methodology described in FIG. 5, the controller only permits the torque to be increased to take the RPM to a specific point, at which point the torque is commanded to a constant level thereby preventing excessive speed and inordinately high power consumption of the air conditioning system.

Advantages may also be seen within ducted air conditioning systems at maximum airflow utilizing the methodology of FIG. 5. In a system employing a constant CFM model, the blower may accelerate to high speed, consume high power, or cause erratic blower operation at excessively high restrictions. With the bin discrete computational processes discussed in FIG. 4, the maximum airflow condition could also be set to a different speed/torque performance equation that would apply at lower airflows. As a result, a self-limiting relationship may be implemented so that the blower motor does not speed up to self-destruction or experience erratic operations.

Referring back to FIG. 2, each curved line represents the maximum torque and speed allowed across the CFM range. Each curve represents a constant CFM up to a point intersecting the limit. The speed/torque response of the motor based upon the improved algorithm is allowed to reach a torque limit appropriate to each airflow across the range of airflows. A minimum torque limit would also be utilized to maintain the appropriate constant CFM.

By utilizing a controller based upon a mathematical model specific to a unique geometry of the blower permits development of algorithms that are suitable for forward curved or backward included blower wheels. Since performance characteristics of these two types of wheels are completely different due to their geometry, it is not practical for one mathematical model to adequately characterize both types of blower wheels. In the preferred embodiment of the present invention, a mathematical model is tailored to each type of blower system and employs the discrete bin equations to fit the performance over a small range of operation. Prior algorithms were not adequately capable of modeling backward-inclined blower wheels. In addition, these existing mathematical models cannot split the performance region into smaller, mathematically definable bins. The preferred embodiment of the present invention permits each bin to be constrained to speeds and torques appropriate to the defined region and permits each region to have unique and separate upper and lower limits on speed and torque. In backward-inclined blower wheels, it is particularly critical to determine these characteristics. The backward-inclined blower wheels exhibit a non-overloading characteristic that causes power to reduce toward free delivery, especially at the lower external pressures at low RPM in a fixed restriction system.

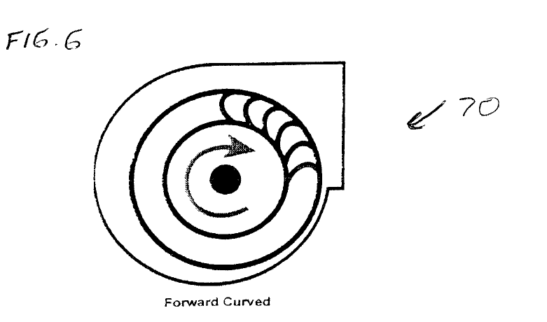

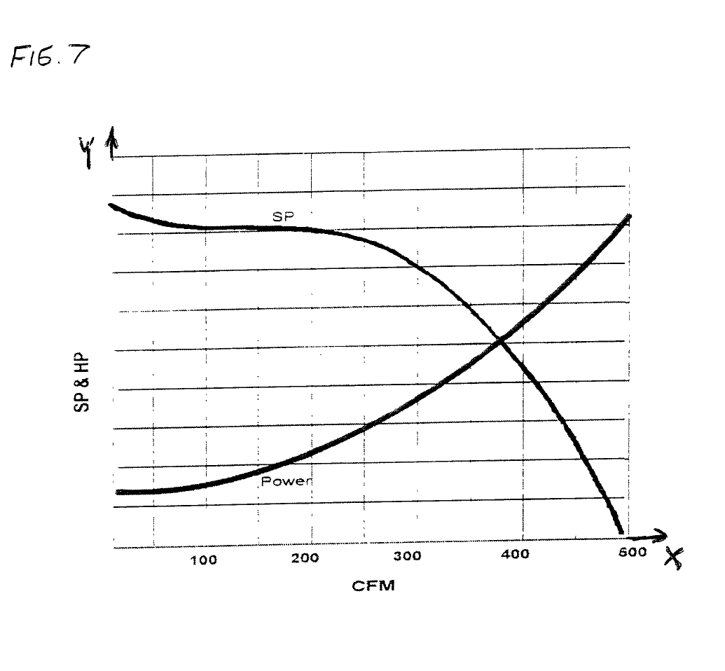

FIG. 6 illustrated a top view of an existing forward curved blower 70. FIG. 7 illustrates the blower characteristics of the exemplary forward curved blower 70 of FIG. 6. As illustrated, the power/torque loading constantly increases.

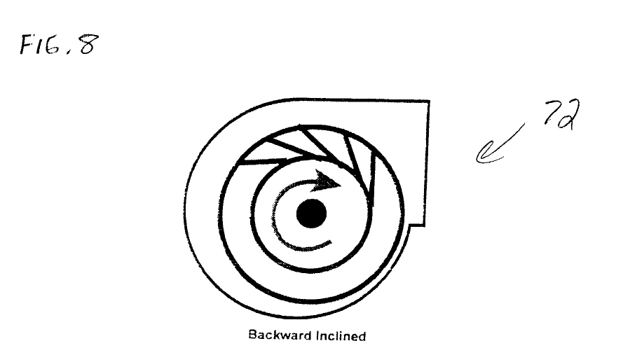

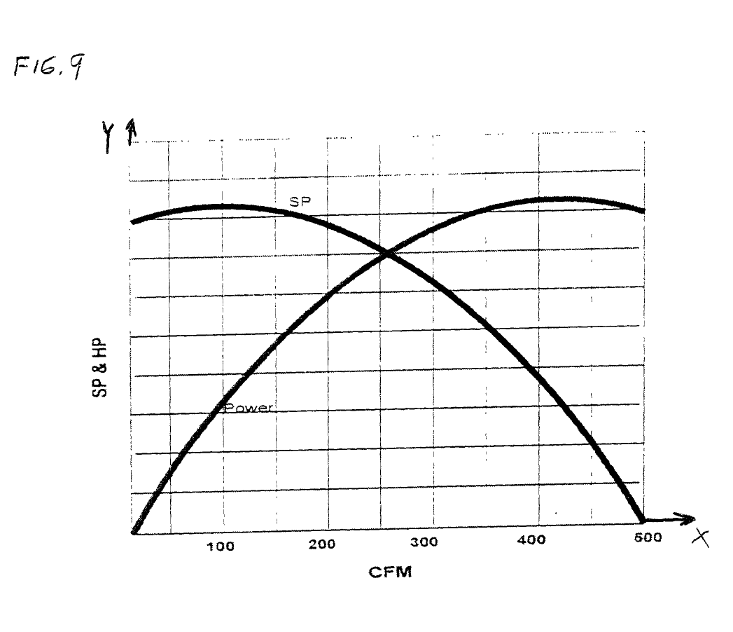

FIG. 8 illustrates a top view of an existing backward-inclined blower 72. FIG. 9 illustrates the blower characteristics of the exemplary backward-inclined blower 72 of FIG. 8. The backward-inclined blower illustrates that power first increases then reduces as the static pressure approaches zero.

Due to the contrasting performance characteristics, it is evident that a discrete regional bin CFM approach is far more accurate and practical then any existing methodology.

It is thus believed that the operation and construction of the present invention will be apparent from the foregoing description. While the system and method shown and described has been characterized as being preferred, it will be readily apparent that various changes and modifications could be made therein without departing from the scope of the invention as defined in the following claims.

What is claimed is:

1. An air delivery system, said air delivery system comprising:
a blower for delivering an air flow to a specified area;
a motor for driving said blower; and
a controller for controlling air delivery to the specified area, said controller determining a torque and revolutions per minute (RPM) of said motor to produce a desired cubic feet per minute (CFM) air flow from a plurality of discrete airflows within bins;
whereby said controller commands said motor to the determined torque and RPM, said motor driving said blower to deliver the air flow at the desired CFM air flow.

2. The air delivery system of claim 1 wherein said controller includes a computing system having a programmed mathematical relationship for finding a plurality of specified CFM air flow based on torque and speed from a plurality of discrete airflows within bins of a specified range.

3. The air delivery system of claim 1 wherein said controller commands said motor to drive said blower to a speed control mode when a specific restriction is inputted to said controller.

4. The air delivery system of claim 1 wherein said controller commands said motor to drive said blower to a torque control mode when a specific restriction is inputted to said controller.

5. A method of controlling an air delivery system, said method comprising the steps of:
determining a total fan performance of a blower over an operational range of the air delivery system;
developing a unique mathematical relationship based on torque and speed of a motor driving the blower to create a plurality of discrete airflows, each discrete airflow providing a specific cubic foot per minute (CFM) air flow; and
utilizing, by a controller of the air delivery system, the unique mathematical relation to control the RPM and torque of the motor to deliver a desired CFM airflow.

6. The method of controlling the air delivery system, wherein said step of developing a unique mathematical relationship includes relating the speed and torque of the motor to a bin developed over a narrow range of restrictions relevant to the desired CFM airflow.

7. A method of controlling an air delivery system utilizing a variable limit, said method comprising the steps of:
determining a total fan performance of a blower over an operational range of the air delivery system;
calculating a unique mathematical relationship of cubic feet per minute (CFM) related to torque and revolutions per minute (RPM) of a motor driving the blower to create a plurality of discrete airflows within the operational range of the air delivery system;
determining if a controlled airflow mode or a constant torque mode is desired for the air delivery system;
if a constant airflow mode is determined, utilizing by a controller of the air delivery system the unique mathematical relationship for a specific discrete airflow to control the RPM and torque of the motor to deliver a desired CFM airflow.

8. The method of controlling an air delivery system utilizing a variable limit of claim 7, further comprising the step of if a constant torque mode is desired for the air delivery system, commanding by the controller a constant torque to the motor to allow the blower to follow a fan curve performance model.

9. The method of controlling an air delivery system utilizing a variable limit of claim 7 wherein each discrete air flow is defined by a unique equation relating speed and torque of the motor over a narrow range of restrictions relevant to that discrete airflow.

10. The method of controlling an air delivery system utilizing a variable limit of claim 7 wherein said step of determining if a constant airflow mode or a constant torque mode is desired for the air delivery system includes determining if the desired CFM airflow results in an excessive speed of the blower.
